(19) United States
(12) Patent Application Publication
(10) Pub. No.: US 2015/0314852 A1
(43) Pub. Date: Nov. 5, 2015

(54) ELECTRONIC FLAP ACTUATION SYSTEM

(71) Applicant: EATON CORPORATION, Cleveland, OH (US)

(72) Inventors: John David Neely, Kentwood, MI (US); Thomas Austen Blair, Grand Rapids, MI (US); Peter Anthony Torres, Plainwell, MI (US)

(21) Appl. No.: 14/648,342

(22) PCT Filed: Mar. 13, 2013
(86) PCT No.: PCT/US13/31011

§ 371 Date: May 29, 2015

Related U.S. Application Data
(60) Provisional application No. 61/734,232, filed on Dec. 6, 2012.

(51) Int. Cl. B64C 9/38

(52) U.S. Cl. CPC B64C 9/38

(57) ABSTRACT

A flap actuation system for an aircraft can include a first flap panel connected with a first in-board actuator and a first out-board actuator. A first electronic control unit (ECU) can be electrically coupled to and configured to control the first in-board actuator, and a second ECU can be electrically coupled to and configured to control the first out-board actuator. The flap system may further include a second flap panel connected with a second in-board actuator and a second out-board actuator. A third ECU can be electrically coupled to and configured to control the second in-board actuator, and a fourth ECU can be electrically coupled to and configured to control the second out-board actuator.

### CROSS-REFERENCE TO RELATED APPLICATIONS

This application is a national stage filing based upon International Application No. PCT/US2013/031011, with an international filing date of Mar. 13, 2013, which claims the benefit of U.S. Provisional Application No. 61/734,232, filed Dec. 6, 2012, the disclosures of which are incorporated herein by reference in their entirety.

### BACKGROUND

1. Technical Field

The present disclosure relates generally to aircraft flap systems, including electronically-synchronized flap systems for fixed-wing aircraft.

2. Description of the Related Art

One known type of fixed-wing aircraft flap system is a fully distributed fly-by-wire flap system. In such a system, each flap actuator—for example, an in-board actuator and an out-board actuator for the left wing, and an in-board actuator and an out-board actuator for the right wing—may be independently positioned and actuated, without any interconnection. As a result, the positions of the actuators, and thus of the flap panels, may be difficult to consistently synchronize.

One conventional solution for synchronizing the positions of flap actuators is embodied in the system 10 shown in FIG. 1. The conventional system 10 relies, generally, on mechanical synchronization of the flap panel actuators. The conventional system 10 can include a flap panel position input 12 using a data and signal communications path 14 to communicate with a flap electronic control unit (ECU) 16, a motor/brake 18, and a power distribution unit (PDU) 20. In the left wing 22_{L}, the conventional system 10 can include a left flap panel 24_{L}, a left in-board actuator 26_{LI}, a left out-board actuator 26_{LO}, and a number of flap position sensors 28. The right wing 22_{R} similarly can include a right flap panel 24_{R}, a right in-board actuator 26_{RI}, a right out-board actuator 26_{RO}, and a number of flap position sensors 28. For visual clarity, not all position sensors 28 are designated.

In the conventional system 10, the common motor/brake 18 can provide power for actuators 26_{LI}, 26_{LO}, 26_{RI}, 26_{RO} in the left wing 22_{L} and right wing 22_{R}, which can be distributed by the PDU 20 to the respective actuators. To distribute power, a mechanical transmission system, such as a series of rotatable flexible torque shafts or torque tubes 30, couples the PDU 20 to the in-board actuators 26_{LI}, 26_{RI} in each wing. Another mechanical transmission, such as flexible shafts or torque tubes 32, couple each in-board actuator 26_{LI}, 26_{RI} with a respective out-board actuator 26_{LO}, 26_{RO}. Thus, a single motor/brake 18 and single PDU 20 drive both flap panels 24_{L}, 24_{R} through mechanical transmissions 30, 32.

Because a single motor/brake 18 and a single PDU 20 are used to provide power to a plurality of flap actuators in both wings, these components along with the mechanical transmissions 30, 32 can be relatively large and heavy. Furthermore, the centrally located motor/brake 18 and PDU 20 can be relatively inefficient. As a result, these conventional systems may often be comparatively heavier and less efficient.

### SUMMARY

In an embodiment, a flap actuation system for an aircraft may include a first flap panel connected with a first in-board actuator and a first out-board actuator. A first electronic control unit (ECU) can be electrically coupled to and configured to control the first in-board actuator, and a second ECU can be electrically coupled to and configured to control the first out-board actuator. The flap system may further include a second flap panel connected with a second in-board actuator and a second out-board actuator. A third ECU can be electrically coupled to and configured to control the second in-board actuator, and a fourth ECU can be electrically coupled to and configured to control the second out-board actuator.

### BRIEF DESCRIPTION OF THE DRAWINGS

Embodiments of the invention will now be described, by way of example, with reference to the accompanying drawings, wherein:

FIG. 1 generally illustrates a schematic of a conventional flap actuation system.

FIG. 2 generally illustrates a schematic of an electronic flap actuation system in accordance with an embodiment of the present disclosure.

FIG. 3 generally illustrates a schematic of an electronic flap panel actuator assembly that may be used in the electronic flap actuation system of FIG. 2.

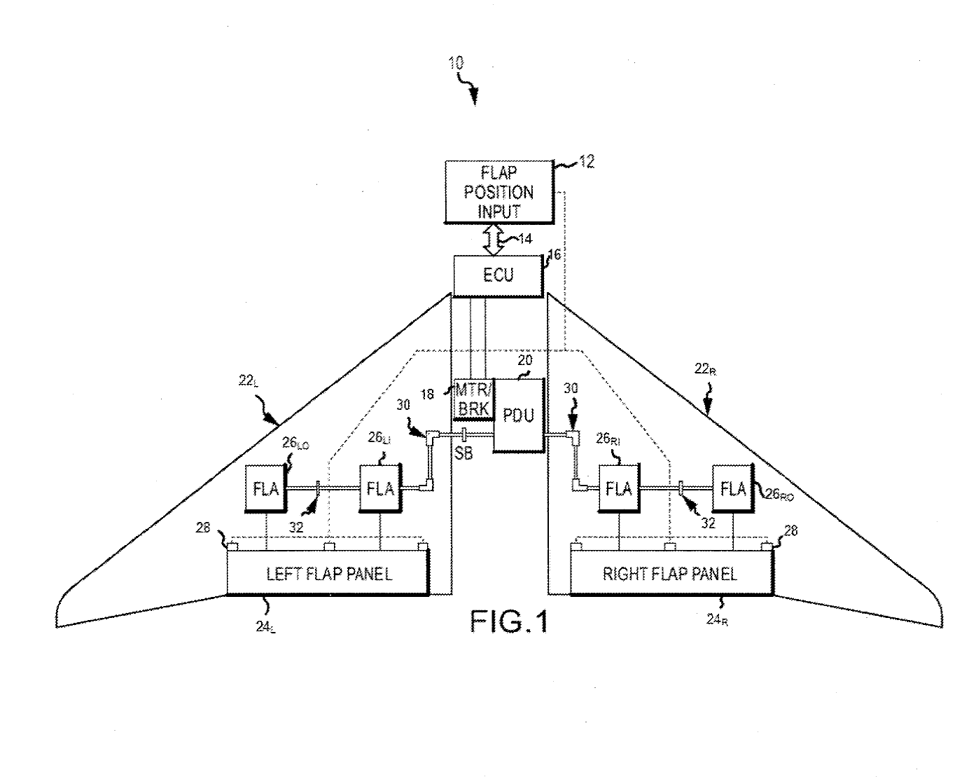

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

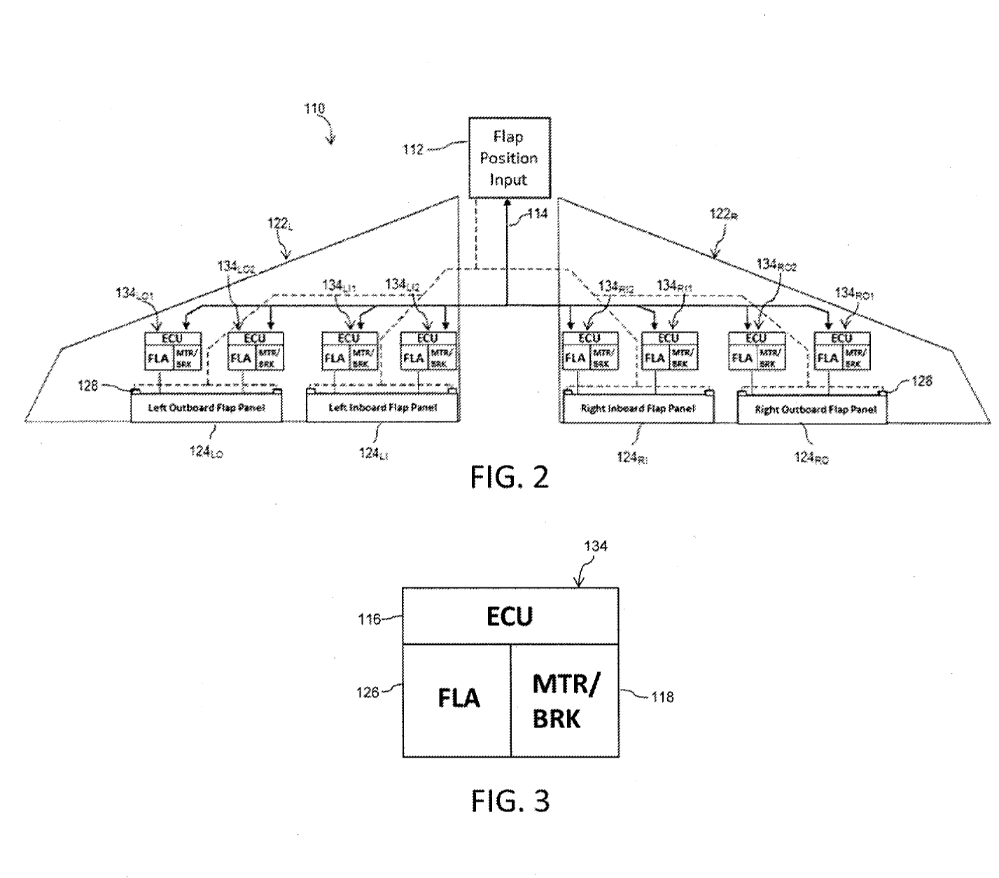

An embodiment of an electronic flap actuation system 110 is generally illustrated in FIG. 2, and an embodiment of an electronic flap panel actuator assembly 134 is shown in greater detail in FIG. 3. The system 110 can include a flap panel position input 112 using a data and signal communications path 114 to communicate with a plurality of electronic flap actuator assemblies 134. The left wing 122_{L} can include an inboard flap panel 124_{LI} mechanically coupled with inboard flap panel actuator assemblies 134_{LI1}, 134_{LI2}, an outboard flap panel 124_{LO} mechanically coupled with outboard flap panel actuator assemblies 134_{LO1}, 134_{LO2}, and a plurality of flap position sensors 128. The right wing 122_{R} similarly can include an inboard flap panel 124_{RI} mechanically coupled with inboard flap panel actuator assemblies 134_{RI1}, 134_{RI2}, an outboard flap panel 124_{RO} mechanically coupled with outboard flap panel actuator assemblies 134_{RO1}, 134_{RO2}, and a plurality of position sensors 128 for sensing a position of the respective flap panels. For visual clarity, not all flap position sensors 128 are designated. Furthermore, it should be understood that although multiple flap panels are illustrated for each wing, the synchronized flap systems described herein can also apply to an aircraft with a single flap panel in each wing.

The flap panel actuator assemblies 134_{LI1}, 134_{LI2}, 134_{LO1}, 134_{LO2}, 134_{RI1}, 134_{RI2}, 134_{RO1}, 134_{RO2} may be collectively referred to herein as the flap panel actuator assemblies 134. A single one of the flap panel actuator assemblies 134 may be referred to as a flap panel actuator assembly 134. Similarly, the flap panels 124_{LO}, 124_{LO}, 124_{RI}, 124_{RO} may be collectively referred to as the flap panels 124, or individually as a flap panel 124. Descriptions of a single flap panel actuator assembly 134 or a single flap panel 124 should be understood to apply equally to each flap panel actuator assembly 134 or to each flap panel 124.

The flap panel position input 112 may, for example, comprise an apparatus known in the art for commanding the position of one or more flap panels. In an embodiment, the flap panel position input 12 can be, for example, a flight control computer or a flap handle. The flap panel position input 12 can output or transmit flap panel commands over the data and signal communications path 114. In an embodiment, the data and signal communications path 114 may operate according to ARINC 825 (i.e., Aeronautical Radio Incorporated) or any other appropriate communications protocol.

As is generally shown in FIG. 3, an embodiment of a flap panel actuator assembly 134 may include an electronic control unit (ECU) 116, a flap actuator (FLA) 126, and a motor/brake (MTR/BRK) 118. As is more clearly shown in FIG. 2, the ECU 116 can be configured to receive commands from a user/pilot, for example, through the flap panel position input 112, and transmit or translate those commands into a position or movement of a respective one of the flap panels 124. The provision of an ECU 116 for each flap actuator 126 allows the flap actuators 126 to be electronically synchronized, rather than mechanically synchronized as described above in a conventional actuation system. To convert commands into movement of a flap panel 124, the ECU 116 can include hardware and/or software-based control (e.g., in the form of algorithms or code) for transmitting or translating user/pilot commands into flap panel control. Further, the plurality of ECUs 116 may be able to communicate with one another or with a main control unit over the data and signal communications path 114. In an embodiment, the ECU 116 and other components in the system 110 can receive power from a 28 volt DC power source for generating control and communication signals, although any suitable power source can be provided.

The operation of the electronic flap actuation system 10 will now be described. To move a flap panel 124, an ECU 116 can issue commands to a motor/brake 118 with which it is coupled. The motor/brake 118 may, in turn, effect movement of (or slow or stop movement of) a respective flap actuator 126. Because each actuator 126 may be coupled with one of the flap panels 124, movement of an actuator 126 may result in a corresponding movement of the respective flap panel 124. For example, the ECU 116 can be configured to control the motor/brake 118 with a set or prescribed velocity and a direction (e.g., extend or retract) to extend or retract the respective flap panel 124. In an embodiment, each motor/brake 118 may receive power from a 115 volt AC power source, although any suitable power source can be provided.

Each motor/brake 118 can include a motor configured to provide power to a flap actuator 126 for moving a respective one of the flap panels 124 and a brake for preventing such movement (i.e., for slowing the movement of or locking the position of the flap panel). It should be understood that the motor and brake portions of each motor/brake 118 may be physically separate components, although they are shown as a unitary assembly. In embodiments, each motor/brake 118 may comprise various acceptable devices or apparatus known in the art that are suitable for such an application.

Proper in-flight operation may require that the flap panels 124 move in a form of synchronization. For this and other reasons, one or more position sensors 128 can be connected to the flap panels 124 and can be configured to sense and/or measure the positions of the flap panels 124. Each ECU 116 can be operatively (e.g., electrically) coupled with the positions sensors 128 for monitoring the position of one or more portions of the flap panels 124. Such a coupling may be indirect, such as through the flap position input 112, for example, or may be direct to each ECU 116. Using position data or measurements provided by the position sensors 128, each ECU 116 can, for example, be configured to determine a configuration or asymmetry of the flap actuator 126 to which it is coupled relative to the other flap actuators 126. In turn, each ECU 116 can determine a configuration or asymmetry between different panels 124 as well as skew of a single flap panel 124. Each ECU 116 can also monitor one or more flap panels 124 for uncommanded/unintentional movement, or for failure to move when commanded, by using feedback from one or more position sensors 128. In an embodiment, position sensors 128 can be, for example and without limitation, various position sensors known in the field for similar applications. Multiple different types of position sensors 128 may be used in a single aircraft or wing or, alternatively, all position sensors 128 may be of the same type.

An ECU 116 can compare, for example and without limitation, various parameters including but not limited to skew, asymmetry, uncommanded/unintentional movement, and/or failed commanded movement to predetermined thresholds associated with failure states of the flap panels 124. The system 110 may be configured so that in the event that readings from one or more position sensors 128 indicate that a failure state has occurred—i.e., that asymmetry, skew, uncommanded/unintentional movement, and/or failed commanded movement is approaching or is beyond a threshold—one or more ECUs 116 can, for example, command the brakes (e.g., via one or more motor/brakes 118) to shut down (i.e., lock) a flap panel 124 to help ensure safety and reliability. In an embodiment, one or more ECUs 116 may be configured to signal or command one or more motor/brakes 118 to correct for some amount of asymmetry or skew.

Electronically-synchronized flap systems 110 such as generally disclosed herein can provide a number of advantages with respect to conventional flap systems. Because each flap actuator 126 can be coupled with its own motor/brake 118 and ECU 116, the need for a large and inefficient centralized PDU, interconnection gear boxes, centralized torque transmission tubes/flex shafts and related support bearings associated with some conventional systems can be reduced or eliminated. As a result, the system 110 can have much lower weight and higher efficiency than a conventional system and may be simpler to install and maintain. In addition, the presence of an independent motor/brake for each flap actuator 126 can allow for the correction of minor skew across one or more flap panels 124 and asymmetry between the positions of one or more of the flap panels 124.

Electronically-synchronized flap systems 110 such as generally disclosed herein can also provide advantages with regards to reliability, installation, and maintenance. For example, critical features such as motor/brake controls and/or position determinations by an ECU 116 are multiplied and redundantly represented in the flap system 110 (e.g., through the use of multiple ECUs 116), thereby increasing the availability of the flap system 110 in the event of device malfunction. Furthermore, because each flap actuator 126 may be mechanically independent of the other flap actuators 126 and may be electronically-controlled independent of the other flap actuators 126, rigging of the flap system 110 (i.e., alignment of the actuators 126 and the flap panels 124 during installation and maintenance) may be simplified. In an embodiment, the system 110 (i.e., each ECU 116) may be configured to automatically rig the actuators 126 and flap panels 124. Such automatic rigging may save significant amounts of time and labor for installation and maintenance, thereby reducing the up-front and maintenance costs of the system 110 when compared to conventional systems.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims and their equivalents.

What is claimed is:

1. A flap system for an aircraft, the flap system comprising:
a first flap panel, the first flap panel connected with a first in-board actuator and a first out-board actuator;
a first electronic control unit (ECU) electrically coupled to and configured to control the first in-board actuator and a second ECU electrically coupled to and configured to control the first out-board actuator;
a second flap panel, the second flap panel connected with a second in-board actuator and a second out-board actuator;
a third ECU electrically coupled to and configured to control the second in-board actuator; and
a fourth ECU electrically coupled to and configured to control the second out-board actuator.

2. The flap system of claim 1, including:
a first position sensor and a second position sensor configured to measure the position of respective portions of the first flap panel; and
a third position sensor and a fourth position sensor configured to measure the position of respective portions of the second flap panel.

3. The flap system of claim 2, wherein at least one of the first ECU, the second ECU, the third ECU, and the fourth ECU is configured to monitor the respective positions of the first and second flap panels according to outputs from the first, second, third, and fourth position sensors.

4. The flap system of claim 3, wherein the first ECU, the second ECU, the third ECU, and the fourth ECU communicate with one another to synchronize the positions of the first and second flap panels.

5. The flap system of claim 3, wherein at least one of the first ECU, the second ECU, the third ECU, and the fourth ECU is configured to control the respective flap actuator to which the ECU is coupled to correct for at least one of (i) asymmetry between the positions of the first and second flap panels and (ii) skew across the respective portions of at least one of the first and second flap panels.

6. The flap system of claim 3, wherein at least one of the first ECU, the second ECU, the third ECU, and the fourth ECU is configured to lock the position of the flap actuator to which the ECU is coupled in the event that the position of at least one of the first and second flap panels indicate a failure state.

7. The flap system of claim 6, wherein at least one of the first ECU, the second ECU, the third ECU, and the fourth ECU compares the position of at least one of the first and second flap panels with a predetermined threshold associated with a failure state.

8. The flap system of claim 6, wherein the failure state comprises one or more of (1) asymmetry between the positions of the first and second flap panels, (2) skew across the respective portions of at least one of the first and second flap panels, (3) undesired movement of at least one of the first and second flap panels, and (4) failure of at least one of the first and second flap panels to move when commanded.

9. The flap system of claim 1, including:
a first motor connected to the first in-board actuator and configured to be controlled by the first ECU;
a second motor connected to the first out-board actuator and configured to be controlled by the second ECU;
a third motor connected to the second in-board actuator and configured to be controlled by the third ECU; and
a fourth motor connected to the second out-board actuator and configured to be controlled by the fourth ECU.

10. The flap system of claim 1, including:
a first brake connected to the first in-board actuator and configured to be controlled by the first ECU;
a second brake connected to the first out-board actuator and configured to be controlled by the second ECU;
a third brake connected to the second in-board actuator and configured to be controlled by the third ECU; and
a fourth brake connected to the second out-board actuator and configured to be controlled by the fourth ECU.

11. The flap system of claim 1, wherein the first ECU, the second ECU, the third ECU, and the fourth ECU are configured to automatically align the respective flap actuators with the first and second flap panels during installation of the flap system.

12. A flap system for an aircraft, the flap system comprising:
a first flap panel including a first position sensor and a second position sensor that detects the position of respective portions of the first flap panel;
a first flap actuator and a second flap actuator connected to the first flap panel at the respective portions near the first and second position sensors;
a first electronic control unit (ECU) in communication with the first position sensor and the first flap actuator, and a second ECU in communication with the second position sensor and the second flap actuator;
a second flap panel including a third position sensor and a fourth position sensor that detects the position of respective portions of the second flap panel;
a third flap actuator and a fourth flap actuator connected to the second flap panel at the respective portions near the third and fourth position sensors; and
a third ECU in communication with the third position sensor and the third flap actuator, and a fourth ECU in communication with the fourth position sensor and the fourth flap actuator.

13. The flap system of claim 12, wherein at least one of the first ECU, the second ECU, the third ECU, and a fourth ECU is configured to monitor the respective positions of the first and second flap panels according to outputs from the first, second, third, and fourth position sensors.

14. The flap system of claim 13, wherein the first ECU, the second ECU, the third ECU, and the fourth ECU communicate with one another to synchronize the relative positions of the first and second flap panels.

15. The flap system of claim 14, wherein at least one of the first ECU, the second ECU, the third ECU, and the fourth ECU is configured to control the respective flap actuator to which the ECU is coupled to correct for at least one of (1) asymmetry between the positions of the first and second flap panels and (2) skew across the respective portions of at least one of the first and second flap panels.

16. The flap system of claim 13, wherein at least one of the first ECU, the second ECU, the third ECU, and the fourth ECU is configured to lock the respective flap actuator to which the ECU is coupled in the event that the position of at least one of the first and second flap panels indicate a failure state.

17. The flap system of claim 16, wherein at least one of the first ECU, the second ECU, the third ECU, and the fourth ECU compares the position at least one of the first and second flap panels with a predetermined threshold associated with a failure state.

18. The flap system of claim 16, wherein the failure state comprises one or more of (1) asymmetry between the positions of the first and second flap panels, (2) skew across the respective portions of at least one of the first and second flap panels, (3) undesired movement of at least one of the first and second flap panels, and (4) failure of at least one of the first and second flap panels to move when commanded.

19. The flap system of claim 12, including:
a first motor connected to the first flap actuator and in communication with the first ECU, wherein the first ECU is configured to control the first motor;
a second motor connected to the second flap actuator and in communication with the second ECU, wherein the second ECU is configured to control the second motor;
a third motor connected to the third flap actuator and in communication with the third ECU, wherein the third ECU is configured to control the third motor; and
a fourth motor connected to the fourth flap actuator and in communication with a fourth ECU, wherein the fourth ECU is configured to control the fourth motor.

20. The flap system of claim 12, including:
a first brake connected to the first flap actuator and in communication with the first ECU, wherein the first ECU is configured to control the first brake;
a second brake connected to the second flap actuator and in communication with the second ECU, wherein the second ECU is configured to control the second brake;
a third brake connected to the third flap actuator and in communication with the third ECU, wherein the third ECU is configured to control the third brake; and
a fourth brake connected to the fourth flap actuator and in communication with a fourth ECU, wherein the fourth ECU is configured to control the fourth brake.
